(19) United States
(12) Patent Application Publication
(10) Pub. No.: US 2025/0018285 A1
(43) Pub. Date: Jan. 16, 2025

(54) NON-TRANSITORY COMPUTER READABLE MEDIUM, COMPUTER DEVICE, AND METHOD

(71) Applicant: SQUARE ENIX CO., LTD., Tokyo (JP)

(72) Inventor: Yuto YAMAMOTO, Tokyo (JP)

(73) Assignee: SQUARE ENIX CO., LTD., Tokyo (JP)

(21) Appl. No.: 18/761,139

(22) Filed: Jul. 1, 2024

(30) Foreign Application Priority Data
Jul. 14, 2023 (JP) 2023-115952

(51) Int. Cl. A63F 13/285; A63F 13/211

(52) U.S. Cl. CPC A63F 13/285; A63F 13/211

(57) ABSTRACT

Some embodiments of the disclosure provide a non-transitory computer-readable medium having recorded thereon a program to be executed in a computer device having a vibration mechanism for generating vibration or in a computer device connected to a vibration device having the vibration mechanism in a wireless or wired manner is provided. The program causes the computer device to perform: calculating a movement vector indicating a movement direction of a moving object or a user's operation point when the moving object or the user's operation point moves on at least one surface of a virtual object; and generating vibration information for controlling an operation of the vibration mechanism, based on a normal vector of the at least one surface located on a movement path of the moving object or the user's operation point and the movement vector, when the moving object or the user's operation point moves along the movement path.

### CROSS-REFERENCE TO RELATED APPLICATION

The present application claims priority to and the benefit of Japanese Patent Application No. 2023-115952 filed on Jul. 14, 2023, the disclosure of which is expressly incorporated herein by reference in its entirety for any purpose.

### BACKGROUND

The disclosure relates to a non-transitory computer readable medium, a computer device, and a method.

In a case of moving on a vehicle in a virtual space or in a case of performing an operation of tracing a surface of a virtual object, a controller or the like held by a user may be vibrated in order to enhance a sense of presence or a sense of immersion of the user. A vibration waveform for controlling such vibration is generally created in advance by a game producer or the like by processing a sound effect in the scene or specifying a frequency or amplitude of a fundamental waveform such as a sine wave or a rectangular wave.

There is also known a technique for changing the amplitude ratio of a vibration waveform created in advance so as to be more suitable for the situation (e.g., PTL 1).
[PTL 1] Japanese Patent Laid-Open No. 2020-130551

However, in the case where the amplitude ratio of the vibration waveform created in advance is changed as in PTL 1, the range of variations of the obtained vibration waveform is limited. On the other hand, it is burdensome for the game producer to previously create a unique vibration waveform for each scene or each virtual object.

It is an object of at least one embodiment of the disclosure to generate vibration information for controlling vibrations imparted to a user by a new method.

### SUMMARY

According to one non-limiting aspect of at least one embodiment of the disclosure, there is provided a non-transitory computer-readable medium having recorded thereon a program to be executed in a computer device having a vibration mechanism for generating vibration or in a computer device connected to a vibration device having the vibration mechanism in a wireless or wired manner, the program, when executed, causing the computer device to perform: calculating a movement vector indicating a movement direction of a moving object or a user's operation point when the moving object or the user's operation point moves on at least one surface of a virtual object; and generating vibration information for controlling an operation of the vibration mechanism, based on a normal vector of the at least one surface located on a movement path of the moving object or the user's operation point and the movement vector, when the moving object or the user's operation point moves along the movement path.

According to another non-limiting aspect of at least one embodiment of the disclosure, there is provided a computer device that includes a vibration mechanism for generating vibration or that is wirelessly or wiredly connected to a vibration device having the vibration mechanism, the computer device configured to: calculate a movement vector indicating a movement direction of a moving object or a user's operation point when the moving object or the user's operation point moves on at least one surface of a virtual object; and generate vibration information for controlling an operation of the vibration mechanism, based on a normal vector of the at least one surface located on a movement path of the moving object or the user's operation point and the movement vector, when the moving object or the user's operation point moves along the movement path.

According to another non-limiting aspect of at least one embodiment of the disclosure, there is provided a method to be executed in a computer device having a vibration mechanism for generating vibration or in a computer device wirelessly or wiredly connected to a vibration device having the vibration mechanism, the method comprising: calculating a movement vector indicating a movement direction of a moving object or a user's operation point when the moving object or the user's operation point moves on at least one surface of a virtual object; and generating vibration information for controlling an operation of the vibration mechanism, based on a normal vector of the at least one surface located on a movement path of the moving object or the user's operation point and the movement vector, when the moving object or the user's operation point moves along the movement path.

One or more deficiencies are solved by embodiments of the disclosure.

### BRIEF DESCRIPTION OF THE DRAWINGS

FIG. 1 is a diagram illustrating an example of a configuration of a computer device and a vibration device corresponding to at least one embodiment of the disclosure.

FIG. 2 is a diagram illustrating an example of a functional configuration of a computer device corresponding to at least one embodiment of the disclosure.

FIG. 3 is a flowchart illustrating an example of a program execution process corresponding to at least one embodiment of the disclosure.

FIG. 4 is a diagram illustrating an example of a configuration of a computer device corresponding to at least one embodiment of the disclosure.

FIG. 5 is a diagram illustrating an example of a functional configuration of a computer device corresponding to at least one embodiment of the disclosure.

FIG. 6 is a flowchart illustrating an example of a program execution process corresponding to at least one embodiment of the disclosure.

FIG. 7 is a diagram illustrating an example of a normal map and a movement path corresponding to at least one embodiment of the disclosure.

FIG. 8 is a diagram illustrating an example of a vibration waveform corresponding to at least one embodiment of the disclosure.

FIG. 9 is a diagram illustrating another example of a normal map and a movement path corresponding to at least one embodiment of the disclosure.

FIG. 10 is a diagram illustrating an example of a virtual object and an operation point corresponding to at least one embodiment of the disclosure.

### DETAILED DESCRIPTION

Hereinafter, examples of embodiments of the disclosure will be described with reference to the drawings. Various constituent elements in the examples of the embodiments described below can be appropriately combined within a range in which no contradiction or the like occurs. Further, description of the content described as an example of a certain embodiment may be omitted in other embodiments. Further, the contents of operations and processes not related to the characteristic portions of the embodiments may be omitted. Further, the sequences of the various processes constituting the various flows described below are different from each other as long as no contradiction occurs in the contents of the processes, and the processes may be executed in parallel.

### First Embodiment

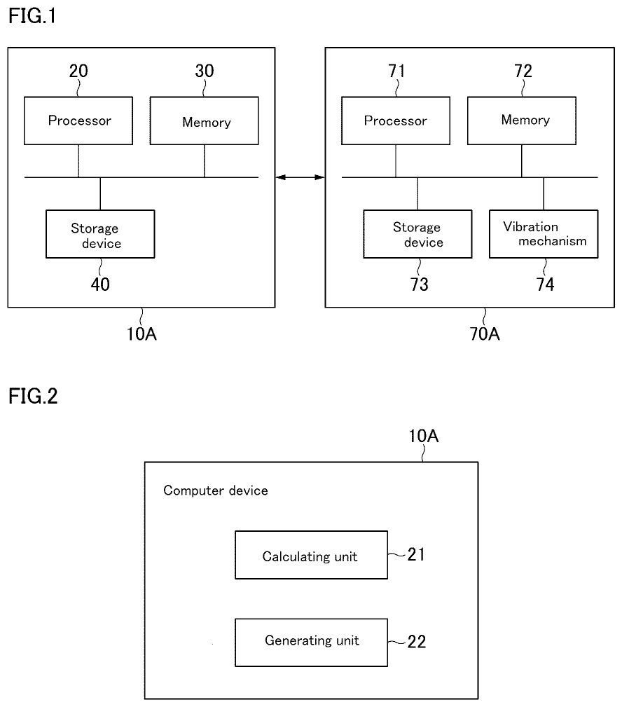

FIG. 1 is a diagram illustrating an example of a configuration of a computer device 10A and a vibration device 70A corresponding to at least one embodiment of the disclosure. As shown in FIG. 1, the computer device 10A can be communicatively coupled, either wirelessly or wired, to a vibration device 70A having a vibration mechanism 74.

The mode of wireless communication is not particularly limited, and for example, a conventionally known technique such as a wireless LAN (Local Area Network) connection such as Wi-Fi, a Bluetooth (registered trademark) connection, or an infrared connection can be appropriately employed. The mode of wired communication is not particularly limited, and for example, a conventionally known technique such as USB (Universal Serial Bus) connection can be appropriately employed. The communication may be short-range communication or long-range communication via a communication network such as the Internet. The communication network may be a so-called blockchain network.

The computer device 10A includes, for example, a processor 20, a memory 30, and a storage device 40. The processor 20, the memory 30, and the storage device 40 are connected to each other via, for example, a communication bus. The computer device 10A may include other conventionally known components.

The processor 20 is, for example, a central processing unit such as a central processing unit (CPU) that performs various calculations and controls. The processor 20 may include a GPU (Graphics Processing Unit) or the like, and may cause the GPU to perform a part of various calculations and controls. For example, the computer device 10A causes the processor 20 to execute various types of information processing using data read out to the memory 30 as appropriate, and causes the storage device 40 to store the obtained processing results as necessary.

The storage device 40 has a function as a storage medium for storing various kinds of information, for example. The configuration of the storage device 40 is not particularly limited, and may include, for example, a ROM (Read Only Memory) in which a program for controlling the operation of the computer device 10A is stored. The ROM is an example of a non-transitory computer-readable medium storing a program. The storage device 40 may include, for example, a hard disk drive (HDD) or a solid state drive (SSD). The storage device 40 may include a storage area in a state of being accessible by the computer device 10A, and for example, may have a configuration in which a dedicated storage area is provided outside the computer device 10A.

The vibration device 70A includes, for example, a processor 71, a memory 72, a storage device 73, and a vibration mechanism 74. The processor 71, the memory 72, the storage device 73, and the vibration mechanism 74 are connected to each other via, for example, a communication bus. The vibration device 70A may include other conventionally known components.

The processor 71 is, for example, a central processing unit such as a CPU that performs various calculations and controls. The vibration device 70A causes the processor 71 to execute various kinds of information processing using data read out to the memory 72 as appropriate, for example. The storage device 73 may include, for example, a ROM (Read Only Memory) in which a program for controlling the operation of the vibration device 70A is stored.

The vibration mechanism 74 is a mechanism that vibrates the vibration device 70A. The configuration of the vibration mechanism 74 is not particularly limited, and a conventionally known configuration can be appropriately employed, but a configuration capable of independently controlling the amplitude and the frequency is preferable. The vibration mechanism 74 may include, for example, a direct current (DC) motor, a voice coil motor, or other technologies. Specifically, the vibration mechanism 74 may include an eccentric motor, a linear resonant actuator, a piezoelectric element, or the like. For example, the processor 71 vibrates the vibration device 70A based on the vibration information received from the computer device 10A. The vibration information output to the vibration device 70A can be demodulated from a digital signal to an analog signal via a D/A (Digital to Analog) converter as necessary.

FIG. 2 is a diagram illustrating an example of a functional configuration of the computer device 10A corresponding to at least one embodiment of the disclosure. The computer device 10A includes at least a calculating unit 21 and a generating unit 22. Each of these units is realized by, for example, the processor 20 specifying at least a part of a program stored in the storage device 40 and developing the program on the memory 30, and the processor 20 operating in cooperation with the memory 30.

When the moving object or the operation point of the user moves on the surface of the virtual object, the calculation unit 21 has a function of calculating a movement vector indicating a movement direction of the movement.

The generation unit 22 has a function of generating vibration information for controlling the operation of the vibration mechanism 74 when the moving object or the operation point moves along the movement path based on a normal vector of each surface located on the movement path of the moving object or the operation point among the surfaces of the virtual object and the movement vector.

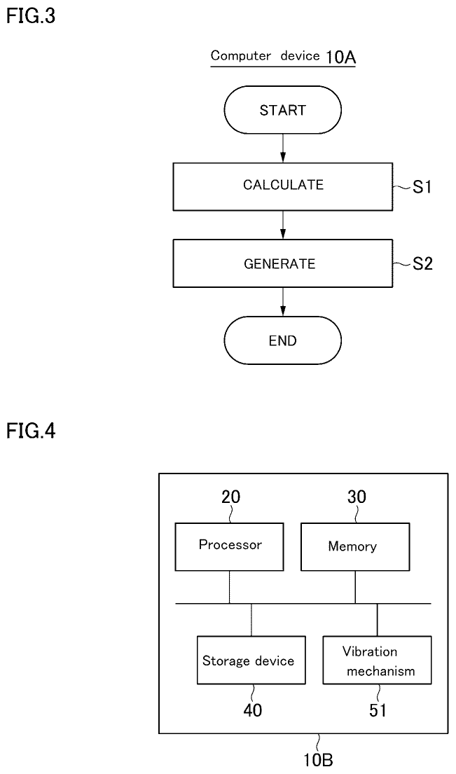

Next, a program execution process according to the first embodiment will be described. FIG. 3 is a flowchart illustrating an example of a program execution process corresponding to at least one embodiment of the disclosure.

In step S1, when the moving object or the operation point of the user (hereinafter, also referred to as “moving object or the like”) moves on the surface of the virtual object, the computer device 10A calculates a movement vector indicating the movement direction of the movement.

In step S2, the computer device 10A generates vibration information for controlling the operation of the vibration mechanism 74 in a case where the moving object or the operation point moves along the movement path based on a normal vector of each surface located on the movement path of the moving object or the operation point among the surfaces of the virtual object and the movement vector.

As an aspect of the first embodiment, vibration information for controlling vibration to be given to a user can be generated by a new method.

In the first embodiment, the “computer device” is, for example, a device capable of presenting a virtual object to a user via an arbitrary display device or the like. Specific examples of the computer device 10A include a mobile phone terminal, a smartphone, PDA (Personal Digital Assistant), a personal computer, a tablet, a stationary game apparatus, and a portable game apparatus. The “computer device” may be a user-operable VR goggle, AR glass, smart glass, AR contact, or other wearable device. Further, the “computer device” may have, for example, a predetermined vibration mechanism, and the “computer device” may also serve as a vibration device.

The “vibration device” is, for example, a device having a predetermined vibration mechanism. The “vibration device” is, for example, a device that causes a user to feel vibration, and is a device that realizes so-called vibration feedback or haptic feedback. Specific examples of the “vibration device” include a controller or the like held by the user, the wearable device or the like worn on the body of the user, and various devices that vibrate a chair or the like on which the user sits.

The term “virtual object” refers to, for example, an object that can be placed in a two-dimensional or three-dimensional virtual world, and may be of any shape, size, texture, or the like. The “virtual object” includes, for example, an object constituted by polygons, and may also include a terrain or the like constituting the virtual world. The “moving object” is, for example, an object that can move in a two-dimensional or three-dimensional virtual world. The “moving object” includes, for example, a vehicle such as a car that moves based on a user's operation. Further, the “moving object” may move in the virtual world regardless of the user's operation.

The “user's operation point” is, for example, a point that moves in the virtual world based on the user's operation. The “user's operation point” may be of any shape, size, or the like. For example, when a device that receives an operation from a user is a touch device, the “user's operation point” can be a point of contact between the user's finger, stylus, or the like and the touch device.

The “movement vector indicating the movement direction” is, for example, a vector in the same direction as the movement direction. The “movement vector indicating the movement direction” may be, for example, a vector in the same direction as the velocity vector of the moving object or the like. Further, the “movement vector indicating the movement direction” may be, for example, a vector in the same direction as the direction from the position of the moving object or the like at an arbitrary time (for example, the current time) toward the position of the moving object or the like after a predetermined unit time has elapsed from the arbitrary time. Further, the “movement vector indicating the movement direction” may be, for example, a unit vector having the above-described direction. Here, the above-described “predetermined unit time” may be, for example, an arbitrary time of 1 to 10 seconds, an arbitrary time of 1 to 60 frames, or another time. The “predetermined unit time” may be appropriately determined according to, for example, the purpose of the program executed by the computer device.

The “normal vector of each surface located on the movement path” is, for example, a normal vector indicated by a pixel located on the movement path among normal vectors indicated in a normal map corresponding to the virtual object. The “normal vector of each surface located on the movement path” may be calculated by a conventionally known method without using a normal map, for example.

The “vibration information” is information for controlling the operation of the vibration mechanism. The “vibration information” may be, for example, information on a waveform indicating the amplitude, frequency, and the like of vibration in the vibration mechanism. Further, the “vibration information” may be, for example, information indicating voltages to be applied to the vibration mechanism in chronological order. Further, the “vibration information” may be, for example, information indicating the displacement amount of the motor included in the vibration mechanism in chronological order.

### Modification of the 1st Embodiment

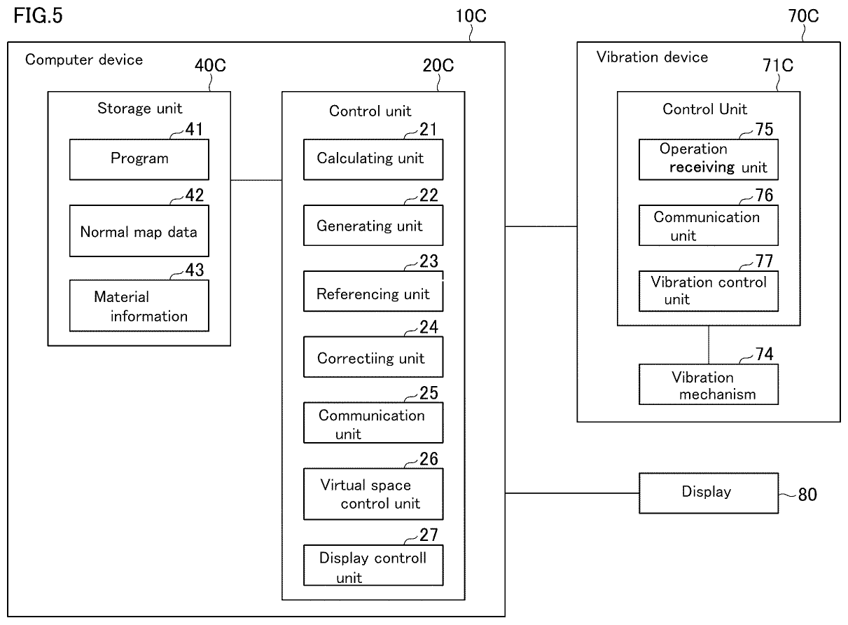

Hereinafter, a modification of the first embodiment will be described with reference to FIG. 4. FIG. 4 is a diagram illustrating an example of a configuration of a computer device 10B corresponding to at least one embodiment of the disclosure.

The computer device 10B includes a processor 20, a memory 30, a storage device 40, and a vibration mechanism 51. For the processor 20, the memory 30, and the storage device 40, the contents described in the first embodiment can be adopted within a range where no contradiction occurs.

The vibration mechanism 51 vibrates the computer device 10B. For the vibration mechanism 51, the contents described for the vibration mechanism 74 in the first embodiment can be adopted within a range where no contradiction occurs.

In the present modification, the computer device 10B itself has a vibration mechanism 51. The computer device 10B vibrates the vibration mechanism 51 based on the vibration information generated by the computer device 10B. That is, in the present modification, at least a part of the computer device 10B vibrates.

With respect to the functional configuration of the computer device 10B and the program execution processing in the present modification, the contents described in the first embodiment can be adopted within a range where no contradiction occurs.

As one aspect of the modification of the first embodiment, the vibration information for controlling the vibration given to the user can be generated by a new method.

In addition, in the present modification, the contents described in the first embodiment can be adopted as the “computer device”, the “vibration device”, the “virtual object”, the “moving object”, the “operation point of the user”, the “movement vector indicating the moving direction”, the “predetermined unit time”, the “normal vector of each surface located on the moving path”, and the “vibration information” within a necessary range.

As one aspect of the modification of the first embodiment, the vibration information for controlling the vibration given to the user can be generated by a new method.

### Second Embodiment

Next, a second embodiment of the disclosure will be described. FIG. 5 is a diagram illustrating an example of a configuration of a computer device 10C and a vibration device 70C corresponding to at least one embodiment of the disclosure. As shown in FIG. 5, the computer device 10C can be communicatively coupled, either wirelessly or wired, to a vibration device 70C having a vibration mechanism 74. Regarding the wireless communication, the contents described in the first embodiment can be adopted within a range where no contradiction occurs.

The computer device 10C includes, for example, a control unit 20C and a storage unit 40C. The storage unit 40C is configured by, for example, a storage device such as a ROM, an HDD, or an SDD. The storage unit 40C stores various programs, data, and the like for operating the computer device 10C. The storage unit 40C may be provided in an external device accessible by the computer device 10C.

The storage unit 40C can store, for example, a program 41, normal map data 42, and material information 43. The program 41 is, for example, a computer program for causing the computer device 10C to realize various functions to be described later.

The normal map data 42 is data of a normal map corresponding to a virtual object. The normal map is, for example, a texture for adding undulations such as unevenness to the surface of the virtual object. The normal map is generally an image in which X, Y, and Z components of a normal vector indicating a direction in which a surface of a polygon constituting a virtual object faces correspond to RGB components, respectively. That is, the RGB components of each pixel included in the normal map indicate the X, Y, and Z components of the normal vector of the pixel. The normal map is preferably stored in advance in the normal map data 42 for each virtual object, for example, but may be created as necessary based on other data such as a height map. Further, for example, in the case of directly expressing concavities and convexities with a polygon without providing normal map data, a normal vector may be directly acquired from the polygon.

The material information 43 is, for example, data representing a material of a virtual object or a moving object. The material information 43 preferably includes, for example, information on the texture and hardness of a virtual object or a moving object. The normal map data 42 may be stored in the storage unit 40C as a type of the material information 43.

The control unit 20C includes, for example, a processor and a memory such as a RAM. By executing the program 41, the control unit 20C of the computer device 10C functions as, for example, the calculation unit 21, the generation unit 22, the reference unit 23, the correcting unit 24, the communication unit 25, the virtual space control unit 26, and the display control unit 27.

The virtual space control unit 26 generates a virtual space including a virtual object based on various data stored in the storage unit 40C, for example. The virtual space may include a moving object. The virtual space control unit 26 controls, for example, an operation of a virtual object or a moving object in the virtual space based on an operation input from a user or a rule set in advance.

The display control unit 27 performs, for example, various controls for displaying the virtual space generated by the virtual space control unit 26 on a predetermined display 80. By the function of the display control unit 27, for example, a state in which the moving object moves on the virtual object is displayed on the display 80. The display 80 may be an external device of the computer device 10C or may be built in the computer device 10C. The display 80 may be a touch panel.

When the moving object or the operation point of the user moves on the surface of the virtual object, the calculation unit 21 has a function of calculating a movement vector indicating a movement direction of the movement. The movement vector calculated by the calculation unit 21 is preferably a unit vector having a predetermined size. In addition, the calculation unit 21 may calculate the magnitude of the movement vector based on, for example, the speed, the acceleration, or the like of the moving object.

For example, when the movement path of the moving object is determined in advance, the calculation unit 21 may calculate the direction of the movement vector based on the movement path. On the other hand, in a case where the movement path of the moving object is not determined in advance and is determined in real time based on an operation input or the like of the user, for example, the calculation unit 21 may set a direction from the position of the moving object or the like at the current time to the position of the moving object or the like after a predetermined unit time has elapsed from the arbitrary time as the direction of the movement vector.

The generation unit 22 has a function of generating vibration information for controlling the operation of the vibration mechanism 74 when the moving object or the operation point moves along the movement path based on a normal vector of each surface located on the movement path of the moving object or the operation point among the surfaces of the virtual object and the movement vector.

For example, the generation unit 22 preferably generates the vibration information based on the inner product of the normal vector and the movement vector. In this case, the vibration information preferably includes a vibration waveform created based on a waveform obtained by arranging inner products of the normal vector and the movement vector in chronological order. For example, the generation unit 22 may generate the vibration information based on a value or the like obtained by substituting the normal vector and the movement vector into a predetermined relational expression.

In addition, for example, it is preferable that the generation unit 22 dynamically generate the vibration information while appropriately calculating the movement vector for each predetermined unit time while the moving object or the like moves on the virtual object. On the other hand, in a case where a subsequent movement path is determined in advance before the moving object moves, the generation unit 22 may generate vibration information corresponding to the movement path in response to the determination of the movement path, for example.

The reference unit 23 has, for example, a function of acquiring a normal vector of each surface with reference to a normal map corresponding to a virtual object. The reference unit 23 refers to, for example, the normal map of the virtual object stored in the normal map data 42.

The correction unit 24 has a function of correcting the vibration information based on, for example, at least one of the material information 43 of the virtual object, the material information 43 of the moving object, and the speed information and the acceleration information of the moving object or the operation point.

For example, when the material information 43 indicates that the virtual object or the moving object is made of a hard material, the correction unit 24 may correct the vibration information so as to increase the vibration, or may perform a high-pass filter process to attenuate a frequency component lower than a predetermined first frequency. On the other hand, for example, when the material information 43 indicates that the virtual object or the moving object is made of a soft material, the correction unit 24 may correct the vibration information so as to reduce the vibration, or may perform a low-pass filter process to attenuate a frequency component higher than a predetermined second frequency. The first frequency and the second frequency are not particularly limited, and may be appropriately set according to the type of the material of the virtual object or the moving object, the situation of the virtual space, or the like.

In addition, the correction unit 24 may correct the vibration information so that the vibration becomes large when the velocity or the acceleration of the virtual object or the moving object is large, for example. On the other hand, for example, when the velocity or acceleration of the virtual object or the moving object is small, the correction unit 24 may correct the vibration information so that the vibration becomes small.

The communication unit 25 functions as, for example, an interface for the computer device 10C to communicate with an external device such as the vibration device 70C. The vibration information generated by the generation unit 22 is subjected to correction by the correction unit 24 as necessary, and then transmitted to the vibration device 70C via the communication unit 25.

The vibration device 70C includes, for example, a control unit 71C and a vibration mechanism 74. The control unit 71C includes, for example, a processor and a memory such as a RAM. When the program for operating the vibration device 70C is executed, the control unit 71C of the vibration device 70C functions as, for example, the operation receiving unit 75, the communication unit 76, and the vibration control unit 77.

The operation receiving unit 75 receives, for example, an input operation of the user. The vibration device 70C may include, for example, various sensors such as a physical button, a touch panel, and a six-axis sensor, and can receive an operation input of a user via these input mechanisms.

The communication unit 76 functions as, for example, an interface for the vibration device 70C to communicate with an external device such as the computer device 10C. The information related to the input operation of the user received by the operation receiving unit 75 is transmitted to the computer device 10C via the communication unit 76, for example. The vibration information generated by the computer device 10C is received by the vibration device 70C via the communication unit 76, for example.

The vibration control unit 77 controls the operation of the vibration mechanism 74 based on, for example, vibration information received from the computer device 10C. The vibration control unit 77 can control the operation of the vibration mechanism 74 based on the amplitude, frequency, and the like of the vibration indicated in the vibration information. As another example, the vibration control unit 77 may control the vibration mechanism 74 such that the motor included in the vibration mechanism 74 is displaced based on the displacement amount in the Z-axis direction included in the vibration information. When the vibration information includes a vibration waveform and the vibration mechanism 74 can operate using the waveform, the vibration control unit 77 preferably demodulates the vibration information from a digital signal to an analog signal via the D/A converter and outputs the demodulated signal to the vibration mechanism 74. Regarding the vibration mechanism 74, the contents described in the first embodiment can be adopted within a range where no contradiction occurs.

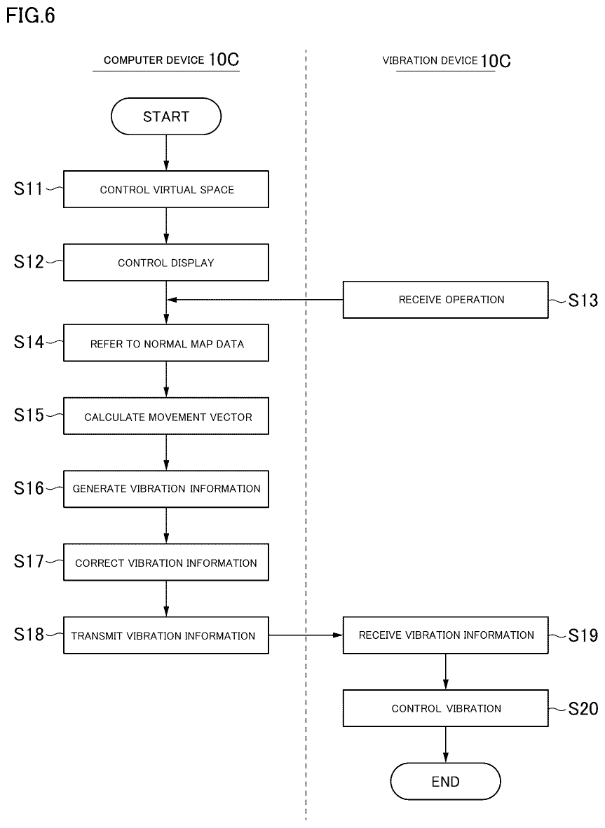

Next, a program execution process according to the second embodiment will be described. FIG. 6 is a flowchart illustrating an example of a program execution process corresponding to at least one embodiment of the disclosure.

In step S11, the computer device 10C generates a virtual space including the virtual object and the moving object. Hereinafter, as the virtual object, a terrain object that forms the ground surface of the virtual space will be described as an example. In addition, as the moving object, a vehicle object that operates based on an operation input of a user is mainly described as an example. Note that the virtual object and the moving object are not limited to these examples.

In step S12, the computer device 10C performs control to display the virtual space generated in step S11 on the display 80 or the like. In step S13, the vibration device 70C receives an operation input from the user. The information related to the operation input from the user is transmitted to the computer device 10C.

Here, it is assumed that an operation of moving the vehicle object on the terrain object is received in step S13. In this case, in step S14, the computer device 10C refers to the normal map data 42 and acquires information on the normal vectors of the surfaces constituting the surface of the terrain object. In step S14, after the movement path of the vehicle object is determined, only the information on the normal vector of the pixel located in the movement path of the vehicle object may be acquired.

In addition, before step S14, it may be determined whether or not the terrain object or the vehicle object is an object to be subjected to vibration generation, and only when it is determined that at least one of the terrain object and the vehicle object is an object to be subjected to vibration generation, the processing after step S14 may be executed. That is, whether or not the virtual object or the moving object is a target of vibration generation may be set in advance.

In step S15, the computer device 10C calculates a movement vector indicating the movement direction of the vehicle object. In step S16, the computer device 10C generates vibration information based on the normal vector acquired in step S14 and the movement vector calculated in step S15. In step S17, the computer device 10C corrects the vibration information generated in step S16 as necessary. That is, step S17 may not be performed.

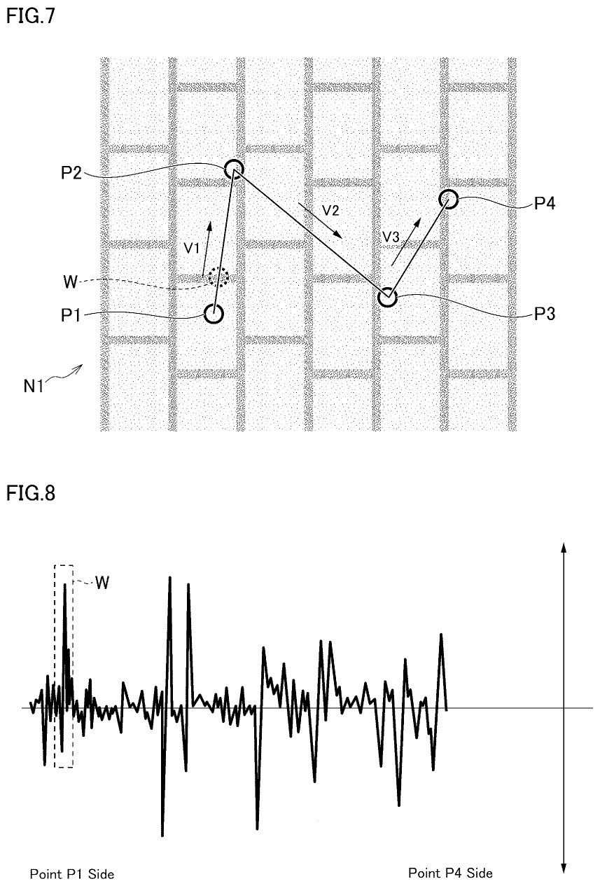

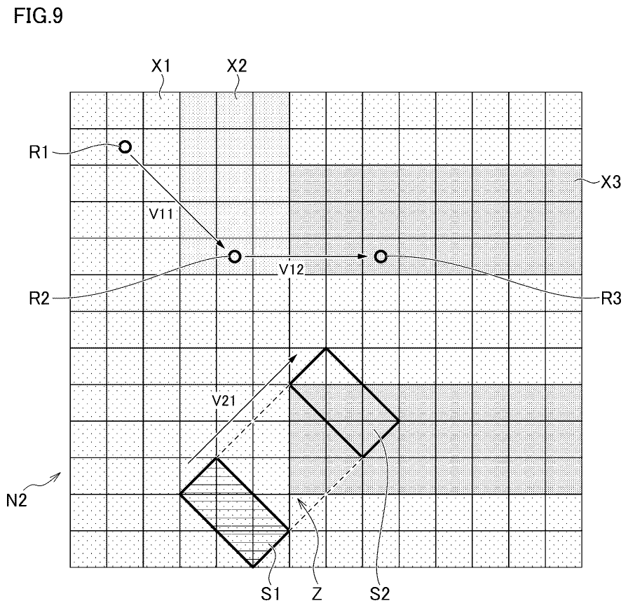

Here, the processing from step S15 to step S17 will be described in detail with reference to FIGS. 7 and 8. FIG. 7 is a diagram illustrating an example of a normal map N1 and a movement path corresponding to at least one embodiment of the disclosure. FIG. 8 is a diagram illustrating an example of a vibration waveform corresponding to at least one embodiment of the disclosure.

In FIG. 7, the movement path when the vehicle object moves on the terrain object is shown on the normal map N1 corresponding to the terrain object. When the vehicle object moves from the point P1 to the point P2, the movement vector calculated in step S15 is, for example, a unit vector having a direction V1 from the point P1 toward the point P2. When the vehicle object moves from the point P2 to the point P3, the movement vector calculated in step S15 is, for example, a unit vector having a direction V2 from the point P2 to the point P3. When the vehicle object moves from the point P3 to the point P4, the movement vector calculated in step S15 is, for example, a unit vector having a direction V3 from the point P3 toward the point P4.

In the present embodiments, it is assumed that the moving object or the like is in contact with the virtual object, that is, is moving while being constrained to the polygon surface of the virtual object. In other words, it is assumed that the moving object or the like is moving in the UV coordinate system. Therefore, when a height difference occurs in the movement vector, it means that the moving object is away from the surface of the virtual object, and in this case, the vibration information may not be generated.

However, the embodiments of the disclosure may be applied to a case where there is a difference in height between the movement paths. For example, when the height coordinates (e.g., y-axis coordinates) of the point P1 and the point P2 are different from each other, the direction of the movement vector may be calculated on the assumption that the height coordinates of the point P1 and the point P2 are different from each other, and the subsequent processing may be performed. Even when the height coordinates (e.g., y-axis coordinates) of the point P1 and the point P2 are different from each other, the direction of the movement vector may be calculated on the assumption that the height coordinates of the point P1 and the point P2 are the same.

In step S16, for example, an inner product of a movement vector and a normal vector indicated by pixels located on the movement path of the vehicle object in the normal map N1 is calculated. As a specific example, when the vehicle object moves from the point P1 to the point P2, an inner product of each normal vector indicated by a pixel at a straight line position from the point P1 to the point P2 and a unit vector having the direction V1 is calculated. The same is true when the vehicle object moves from the point P2 to the point P3 and when the vehicle object moves from the point P3 to the point P4.

FIG. 8 is a vibration waveform in which the inner products of the normal vectors of the pixels located on the movement paths of the point P1, the point P2, the point P3, and the point P4 and the movement vectors are arranged in the order of movement (i.e., in chronological order). The vibration waveform shown in FIG. 8 is an example of the vibration information generated in step S16. The vertical axis in FIG. 8 indicates, for example, a value proportional to the speed of the moving object or the like in a predetermined direction (for example, the Z-axis direction).

One of the reasons why the value based on the velocity in the predetermined direction can be used as the drive signal of the vibration mechanism is that the principles of the speaker and the vibration mechanism are the same. Here, a sound signal by the dynamic microphone in the case of sound will be described. In a dynamic microphone, when a plate and a coil attached to the plate are shaken by sound, a voltage proportional to a moving speed of the coil is generated by electromagnetic induction, and the voltage is used as an audio signal. When the audio signal is input to the speaker, a sound is reproduced. The inventor of the disclosure has found that a signal (waveform) in which velocities in a vibration direction of a moving object or the like are arranged in chronological order can be used as a drive signal of a vibration mechanism including a voice coil motor, a linear resonant actuator, a piezo element, and the like, focusing on the same principle of the vibration mechanism including the speaker to be subjected to the above-described processing. In the case of an eccentric motor or the like that is difficult to control with the above waveform, for example, it is preferable to analyze the waveform between step S17 and step S18 described later or in step S20 described later and convert the waveform into information suitable for the vibration mechanism.

Here, the range W in the normal map N1 in FIG. 7 is, for example, a portion corresponding to a groove in the terrain object. In the case of performing the processing as in step S16, when the vehicle object passes through a portion having a large unevenness such as the range W, the vibration tends to be larger than that of a portion having a small unevenness such as before and after the range W (see the range W and the front and rear of the range W in the vibration waveform in FIG. 8).

In addition, in a case where the material constituting the terrain object is different between the route from the step point P1 to the point P2 and the route from the step point P2 to the point P3, the vibration information illustrated in FIG. 8 can be corrected in step S17. For example, when the material constituting the path from the point P1 to the point P2 of the terrain object is set to be softer than the material constituting the path from the point P2 to the point P3, the vibration from the point P1 to the point P2 may be corrected to be smaller than that shown in FIG. 8, and the vibration from the point P2 to the point P3 may be corrected to be larger than that shown in FIG. 8. As described above, a low-pass filter process or a high-pass filter process may be performed.

When the movement path of the vehicle object is determined in advance, in step S16, it is preferable to generate vibration information corresponding to the movement path at an appropriate timing after the movement path is determined. For example, in a case where it is determined that the vehicle object moves from the point P1 to the point P2 to the point P3 to the point P4 before the vehicle object starts to move, it is preferable to obtain the inner product of each normal vector and each movement vector on these paths and generate vibration information as shown in FIG. 8 in which the inner products are arranged in chronological order before the vehicle object starts to move.

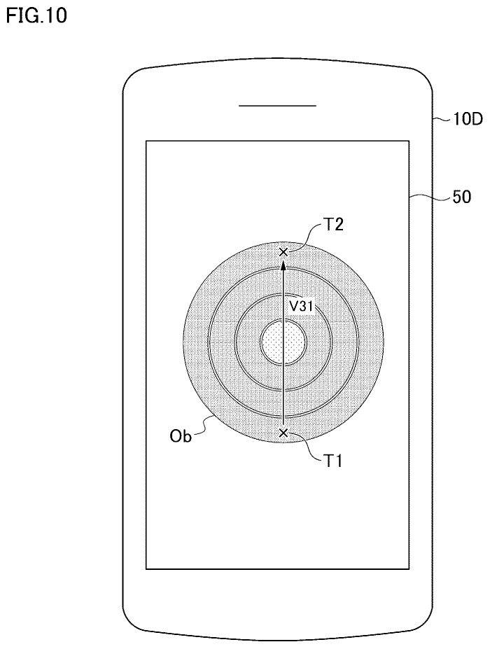

Next, the processes of steps S15 and S16 will be described in more detail with reference to FIG. 9. FIG. 9 is a diagram illustrating an example of a normal map N2 and a movement path corresponding to at least one embodiment of the disclosure. FIG. 9 illustrates an example of a case where the movement path of the vehicle object is not determined in advance and a case where the vehicle object has a predetermined size, such as a case where the movement path is changed based on an operation input of the user.

In FIG. 9, the movement path when the vehicle object moves on the terrain object is shown on the normal map N2 corresponding to the terrain object. The normal map N2 includes a plurality of pixels X1, a plurality of pixels X2, and a plurality of pixels X3. The pixels having the same sign have the same normal vector.

In the example of FIG. 9, the movement path of the vehicle object is not determined in advance, and the movement path is changed based on the operation input of the user. In such a case, for example, it is preferable to calculate the position of the vehicle object every time a predetermined unit time elapses, such as every frame, calculate a movement vector in a predetermined unit time from these positions, and dynamically generate vibration information every predetermined unit time.

For example, consider a case where the vehicle object is located at the point R1, moves to the point R2 after one frame based on an operation input by the user, and moves to the point R3 after one frame after the movement direction is changed based on an operation input by the user. In this case, the movement vector calculated in step S15 is calculated for each frame. When the vehicle object moves from the point R1 to the point R2, the movement vector calculated in step S15 is, for example, a unit vector having a direction V11 from the point R1 toward the point R2. When the vehicle object moves from the point R2 to the point R3, the movement vector calculated in step S15 is, for example, a unit vector having a direction V12 from the point R2 toward the point R3.

The movement vector when the vehicle object moves from the point R1 to the point R2 may be calculated when the vehicle object actually arrives at the point R2, or may be calculated before the vehicle object actually arrives at the point R2 based on the position of the point R2 calculated in advance from the operation input of the user or the like.

When the vehicle object moves from point R1 to point R2, the vehicle object passes through two pixels X1 and two pixels X2 in this order. Therefore, in step S16, vibration information in the movement path from the point R1 to the point R2 is generated by arranging the value of the inner product of the unit vector having the direction V11 and the normal vector indicated by the pixel X1 and the same value as the inner product, and the value of the inner product of the unit vector having the direction V11 and the normal vector indicated by the pixel X2 and the same value as the inner product in this order. Thereafter, the vibration information in the movement path from the point R2 to the point R3 is generated in the same procedure.

This case (the vehicle object is the point R1→the point R2→the point R3) is an example in which it is assumed that the contact point between the vehicle object and the terrain object is a point smaller than one pixel of the normal map. The position of the contact point may be appropriately set according to the type, form, or the like of the vehicle object.

On the other hand, the case in which the vehicle object moves from the position S1 to the position S2 is an example in which the contact point between the vehicle object and the terrain object is larger than one pixel of the normal map. Specifically, this is an example of a case where the ground contact area is set to the tire of the vehicle object.

When the vehicle object moves from the position S1 to the position S2, the direction of the movement vector can be determined based on, for example, the trajectory of movement of a predetermined point such as the center point or the center-of-gravity point. In the example of FIG. 9, the movement vector when the vehicle object moves from the position S1 to the position S2 is a unit vector having a direction V21.

As described above, when the contact point between the vehicle object and the terrain object is larger than one pixel of the normal map, it is preferable to generate the vibration information on the basis of the movement path through which a predetermined point such as the center point or the center of gravity of the contact point passes, that is, on the assumption that the contact point between the vehicle object and the terrain object is smaller than one pixel of the normal map.

On the other hand, an inner product of each normal vector of each pixel included in the region Z, which is a region through which the vehicle object passes, and a unit vector having the direction V21 may be obtained for each time series, and vibration information may be generated based on the inner product in each time series. In this case, for example, the vibration information may be created based on the sum of the inner products in each time series, or the vibration information may be created by substituting the inner products in each time series into a predetermined relational expression.

The description returns to the flowchart of FIG. 6. In step S18, the computer device 10C transmits the vibration information generated in step S16 and corrected in step S17 as necessary to the vibration device 70C.

In step S19, the vibration device 70C receives the vibration information transmitted from the computer device 10C in step S18.

In step S20, the vibration device 70C vibrates the vibration mechanism 74 based on the vibration information received in step S19, performs vibration feedback or haptic feedback to the user, and ends the process.

As an aspect of the second embodiment, vibration information for controlling vibration to be given to a user can be generated by a new method. As an aspect of the second embodiment, for example, even if vibration information of vibration generated when moving on the surface of a virtual object is not created in advance, it is possible to dynamically generate vibration information suitable for the scene.

As an aspect of the second embodiment, by acquiring a normal vector with reference to a normal map, for example, a processing load of a computer device can be reduced.

As an aspect of the second embodiment, by generating the vibration information based on the inner product of the normal vector and the movement vector, for example, the vibration information can be easily generated.

As an aspect of the second embodiment, the vibration information includes a vibration waveform generated based on a waveform obtained by arranging the inner products in chronological order, and thus, for example, operation control of the vibration mechanism is facilitated. In addition, for example, in a case where the vibration mechanism includes a voice coil motor or the like, it is possible to provide a more complicated tactile sense than in a case where a single basic waveform is reproduced by specifying a frequency and an amplitude.

As an aspect of the second embodiment, for example, more realistic vibration feedback or haptic feedback can be performed by correcting vibration information based on at least one of material information of a virtual object, material information of a moving object, and velocity information and acceleration information of a moving object or an operation point.

In the second embodiment, the contents described in the first embodiment can be adopted as “computer device”, “vibration device”, “virtual object”, “moving object”, “operation point of the user”, “movement vector indicating the moving direction”, “predetermined unit time”, “normal vector of each surface located on the moving path”, and “vibration information” within a necessary range.

### Modification of the 2nd Embodiment

Hereinafter, a modification of the second embodiment will be described with reference to FIG. 10. FIG. 10 is a diagram illustrating an example of a virtual object Ob and an operation point corresponding to at least one embodiment of the disclosure.

In the example of FIG. 10, the computer device 10D includes the touch panel 50 and the vibration mechanism 51. An example of such a computer device 10D is a smartphone. In this modification, the contents described in the second embodiment can be adopted within a range where no contradiction occurs. In the present modification, at least a part of the processing performed in the vibration device 70C in the second embodiment is executed in the computer device 10D.

In the example of FIG. 10, the virtual object Ob is displayed on the touch panel 50. In this case, it is assumed that the user touches a predetermined point T1 on the virtual object Ob and performs an operation of swiping to the point T2 as it is. At this time, the operation point of the user moves from the point T1 to the point T2 on the virtual object Ob.

In this case, for example, a unit vector having a direction V31 from the point T1 toward the point T2 is calculated as a movement vector indicating a movement direction when the operation point moves on the surface of the virtual object Ob from the point T1 toward the point T2. Further, by referring to the normal map of the virtual object Ob, a normal vector of each plane on the movement path of the operation point is acquired. Then, for example, an inner product of the movement vector and each normal vector is obtained, and the inner products are arranged in chronological order to generate vibration information.

In this case, the height difference of the movement path of the operation point may not be considered. That is, the direction of the movement vector may be calculated on the assumption that the height coordinates of the point T1 and the point T2 are the same. On the other hand, the height difference of the movement path of the operation point may be considered. In this case, for example, the movement vector in consideration of the height difference may be calculated based on the height coordinates of the position indicated by the point T1 in the virtual object Ob and the height coordinates of the position indicated by the point T2 in the virtual object Ob.

The example of FIG. 10 is also applicable to a case where a controller or the like includes a touch panel, for example.

As one aspect of the modification of the second embodiment, the vibration information for controlling the vibration given to the user can be generated by a new method.

As one aspect of the modification of the second embodiment, for example, in a case where a computer device or a vibration device includes a touch panel, realistic vibration feedback or haptic feedback can be performed.

In addition, in the present modification, the contents described in the first embodiment can be adopted as the “computer device”, the “vibration device”, the “virtual object”, the “moving object”, the “operation point of the user”, the “movement vector indicating the moving direction”, the “normal vector of each surface located on the moving path”, and the “vibration information”, respectively, within a necessary range.

Although various embodiments of the disclosure have been described in detail above, embodiments of the disclosure are not limited thereto. It will be understood by those skilled in the art that embodiments of the disclosure may extend beyond the specifically described embodiments to other alternative embodiments and/or uses and modifications and equivalents thereof. In addition, other modifications which are within the scope of the disclosure will be readily apparent to those of skill in the art based on the described embodiments. It is also contemplated that various combination or sub-combination of the specific features and aspects of the embodiments may be made and still fall within the scope of the disclosure. It should be understood that various features and aspects of the embodiments can be combined with or substituted for one another in order to form varying mode of the embodiments. Thus, it is intended that the scope of the disclosure should not be limited by the particular embodiments described above.

### APPENDIXES

Based on the above descriptions, a person having ordinary skill in the art can practice at least the following embodiments.

{1} A non-transitory computer-readable medium having recorded thereon a program to be executed in a computer device having a vibration mechanism for generating vibration or in a computer device connected to a vibration device having the vibration mechanism in a wireless or wired manner, the program, when executed, causing the computer device to perform:
calculating a movement vector indicating a movement direction of a moving object or a user's operation point when the moving object or the user's operation point moves on at least one surface of a virtual object; and
generating vibration information for controlling an operation of the vibration mechanism, based on a normal vector of the at least one surface located on a movement path of the moving object or the user's operation point and the movement vector, when the moving object or the user's operation point moves along the movement path.

{2} The non-transitory computer-readable recording medium according to {1}, wherein the program further causes the computer to perform referring to a normal map corresponding to the virtual object to acquire the normal vector of the at least one surface.

{3} The non-transitory computer-readable recording medium according to {1} or {2}, wherein generating the vibration information including generating the vibration information based on an inner product of the normal vector and the movement vector.

{4} The non-transitory computer-readable recording medium according to {3}, wherein the vibration information includes a vibration waveform created based on a waveform obtained by arranging the inner products in chronological order.

{5} The non-transitory computer-readable recording medium according to {1} or {2}, the functions further comprising correcting the vibration information based on at least one of material information of the virtual object, material information of the moving object, velocity information of the moving object or the user's operation point, or acceleration information of the moving object or the operation point.

{6} A computer device that includes a vibration mechanism for generating vibration or that is wirelessly or wiredly connected to a vibration device having the vibration mechanism, the computer device configured to:
calculate a movement vector indicating a movement direction of a moving object or a user's operation point when the moving object or the user's operation point moves on at least one surface of a virtual object; and
generate vibration information for controlling an operation of the vibration mechanism, based on a normal vector of the at least one surface located on a movement path of the moving object or the user's operation point and the movement vector, when the moving object or the user's operation point moves along the movement path.

{7} A method to be executed in a computer device having a vibration mechanism for generating vibration or in a computer device wirelessly or wiredly connected to a vibration device having the vibration mechanism, the method comprising:
calculating a movement vector indicating a movement direction of a moving object or a user's operation point when the moving object or the user's operation point moves on at least one surface of a virtual object; and
generating vibration information for controlling an operation of the vibration mechanism, based on a normal vector of the at least one surface located on a movement path of the moving object or the user's operation point and the movement vector, when the moving object or the user's operation point moves along the movement path.

What is claimed is:

1. A non-transitory computer-readable medium having recorded thereon a program to be executed in a computer device having a vibration mechanism for generating vibration or in a computer device connected to a vibration device having the vibration mechanism in a wireless or wired manner, the program, when executed, causing the computer device to perform:
calculating a movement vector indicating a movement direction of a moving object or a user's operation point when the moving object or the user's operation point moves on at least one surface of a virtual object; and
generating vibration information for controlling an operation of the vibration mechanism, based on a normal vector of the at least one surface located on a movement path of the moving object or the user's operation point and the movement vector, when the moving object or the user's operation point moves along the movement path.

2. The non-transitory computer-readable medium according to claim 1, wherein the program further causes the computer device to perform referring to a normal map corresponding to the virtual object to acquire the normal vector of the at least one surface.

3. The non-transitory computer-readable medium according to claim 1, wherein generating the vibration information includes generating the vibration information based on an inner product of the normal vector and the movement vector.

4. The non-transitory computer-readable medium according to claim 3, wherein the vibration information includes a vibration waveform created based on a waveform obtained by arranging the inner products in chronological order.

5. The non-transitory computer-readable medium according to claim 1, wherein the program further causes the computer device to perform correcting the vibration information based on at least one of material information of the virtual object, material information of the moving object, velocity information of the moving object or the user's operation point, or acceleration information of the moving object or the user's operation point.

6. A computer device that includes a vibration mechanism for generating vibration or that is wirelessly or wiredly connected to a vibration device having the vibration mechanism, the computer device configured to:
calculate a movement vector indicating a movement direction of a moving object or a user's operation point when the moving object or the user's operation point moves on at least one surface of a virtual object; and
generate vibration information for controlling an operation of the vibration mechanism, based on a normal vector of the at least one surface located on a movement path of the moving object or the user's operation point and the movement vector, when the moving object or the user's operation point moves along the movement path.

7. A method to be executed in a computer device having a vibration mechanism for generating vibration or in a computer device wirelessly or wiredly connected to a vibration device having the vibration mechanism, the method comprising:
calculating a movement vector indicating a movement direction of a moving object or a user's operation point when the moving object or the user's operation point moves on at least one surface of a virtual object; and
generating vibration information for controlling an operation of the vibration mechanism, based on a normal vector of the at least one surface located on a movement path of the moving object or the user's operation point and the movement vector, when the moving object or the user's operation point moves along the movement path.
